(19) United States
(12) Patent Application Publication
(10) Pub. No.: US 2017/0210513 A1
(43) Pub. Date: Jul. 27, 2017

(54) METHOD OF MAKING PACKAGES HAVING RE-CLOSABLE ZIPPER ON ONE PANEL AND PACKAGE THEREOF

(71) Applicant: Ashok CHATURVEDI, New Delhi (IN)

(72) Inventor: Ashok CHATURVEDI, New Delhi (IN)

(21) Appl. No.: 15/115,330

(22) PCT Filed: Jan. 29, 2015
(86) PCT No.: PCT/IN2015/000056

§ 371 Date: Jul. 29, 2016

(30) Foreign Application Priority Data
Jan. 30, 2014 (IN) 285/DEL/2014

(51) Int. Cl. B65D 33/25; B65D 33/08; B65D 33/34; B65D 30/08; B65D 30/20

(52) U.S. Cl. CPC B65D 33/2591; B65D 31/04; B65D 31/10; B65D 33/34; B65D 33/08; B31B 37/00; B31B 2219/145; B31B 2219/2681; B31B 2219/603; B31B 2219/9019; B31B 2219/9093; B31B 2237/20; B31B 2237/406; B31B 2237/50

(57) ABSTRACT

The present invention provides a method of making re-closable package (10) and a product made therefrom. The said method comprises providing a first web (46) and a second web (50), folding a predetermined portion (P) of the first web (46) into a V-shape (58) thereby forming an extended portion and cutting the V-shape (58) of the first web (46) to form a pair of extended panels (62). A re-closable zipper (42) sealed with the extended panels (62). The first web (46) sealed with the second web (50) at a first sealing zone (SZ1) and second sealing zone (SZ2). Subsequently, cut the first web (46) and the second web (50) at the first sealing zone (SZ1) thereby obtaining a re-closable package (10). The said re-closable package (10) comprising a first panel (14), a second panel (18) and optionally side gussets (22, 26) and a bottom gusset (30).

### FIELD OF THE PRESENT INVENTION

The present invention generally relates to flexible packaging and more particularly relates to a method of making packages having a re-closable zipper on one panel and a package made therefrom.

### BACKGROUND

Generally slider-operated flexible zippers are being used in re-closable pouches, bags or other packages of the type in which material, such as foodstuff, detergent, etc., may be packed.

Re-closable fastener assemblies are useful for sealing thermoplastic pouches or bags. Such fastener assemblies often include a zipper and a slider. Typically, the zippers include a pair of interlockable fastener elements, or profiles, that form a closure. As the slider moves over the profiles, the profiles are opened or closed. The profiles of locking members of zippers can take on various configurations, e.g. interlocking rib and groove elements so-called male and female profiles, interlocking hook-shaped closure members, etc.

Nowadays flexible packages are provided with a zipper that is being sealed at both the panels of the package and a tamper evident diaphragm is provided at the end of the zipper. But sealing of the zipper and also providing hermetic sealing simultaneously is very cumbersome. Moreover it is inconsistent to access slider deep inside the slide panels of bag having handle punching.

One easy solution is to such problem of providing both tamper evidence hermetic sealing and easy operation of the slider is to manufacture packages wherein the slider-zipper assembly is enclosed by a header as mentioned in U.S. Pat. No. 7,331,160. Before anyone can open the zipper and tamper with the contents of the package, the header must be torn at least partly, leaving evidence of tampering for the buyer any consumer from buying that package. But in such bags after tearing the header, handles cannot be retained.

Another solution to such problem is provided as mentioned in U.S. Pat. No. 6,991,372 is that a window in the of panel of the package is cut and is sealed with the zipper slider along with tamper evident diaphragm on the same cut panel. Since sealing is again done over the cut window, the sealing acquires a sealed portion which reduces the width of the opening of the package through the zipper when opened and thereby accessing the content from the package becomes difficult.

Accordingly, there exists a need of a package that can have a zipper on one of the panel and have maximum possible opening so that one can easily put his hand inside the opening to access the content and accessing slider for opening and closing the zipper is also easy.

### SUMMARY OF THE PRESENT INVENTION

The present invention provides a package that has a zipper on at least one of the panels and have appropriate opening so that one can easily put his hand inside the opening to access the content.

To achieve the above objectives, in an embodiment of the present invention a re-closable package is described. The re-closable package comprises a first panel, a second panel, sealed together to form a volume in the said re-closable package. The first panel further comprises an extended panels and a zipper is sealed to the extended panels.

In another embodiment a method of making re-closable package is described. The method comprises steps of pulling a first panel and a second panel. The width of the second panel is being less than that of the first panel. A portion of the first panel is folded in V-shape. The V-shape of the first panel is slit in the middle, thereby forming extended panels. A zipper is sealed with the inside of extended panels via a zipper sealer. The first panel is sealed with the second panel at a first sealing zone (SZ1), wherein the first sealing zone (SZ1) is at predefined location transverse to the movement of the first panel and the second panel. The sealing zone (SZ1) forms a sealing band between two consecutive packages. The first panel is sealed with the second panel at a second sealing zone (SZ2), wherein the second sealing zone (SZ2) is a predefined location along the movement of the first panel and the second panel, the first panel is cut at the first sealing zone (SZ1), thereby forming the re-closable package.

These together with the other embodiments of the present invention, along with the various features of novelty that characterize the present invention, are pointed out with particularity in the description, along with the abovementioned summary, annexed hereto and form a part of the present invention. For a better understanding of the present invention, it's operating advantages and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention shall be better understood with reference to the following description taken in conjunction with the accompanying drawing, wherein like elements are identified with like symbols and in which:

FIG. 1 illustrates a 3 side re-closable gusseted package in standing position according to one of the embodiment of the present invention;

FIG. 2 illustrates a front, back, sides and bottom view of the 3 side gusseted re-closable package according to one of the embodiment of the present invention;

FIGS. 3-8 illustrate various steps for forming the 3 side gusseted re-closable package according to one of the embodiment of the present invention.

Like reference numerals refer to like parts throughout the description of several views of the drawings.

### DETAILED DESCRIPTION OF THE PRESENT INVENTION

For a thorough understanding of the present invention, reference is to be made to the following detailed description in connection with the above-mentioned drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the present invention. Further, it will nevertheless be understood that no limitation in the scope of the disclosure is thereby intended, such alterations and further modifications in the figures and such further applications of the principles of the present invention as illustrated therein being contemplated as would normally occur to one skilled in the art to which the invention relates. Also, it is to be understood that the phraseology and terminology used herein is for the purpose of description and should not be regarded as limiting. Further, reference herein to “one embodiment” or “an embodiment” means that a particular feature, characteristic, or function described in connection with the embodiment is included in at least one embodiment of the invention. Furthermore, the appearances of such phrase at various places herein are not necessarily all referring to the same embodiment. The terms “a” and “an” herein do not denote a limitation of quantity, but rather denote the presence of at least one of the referenced item. Moreover, the term “inner surface/layer” used herein above and/or below may be interchangeably used as an “inner surface” or an “inner layer” throughout the invention. Further, the term “outer surface/layer” used herein above and/or below may be interchangeably used as an “outer surface” or an “outer layer” through.

In various exemplary embodiments, the package (10) may be made by using various kind of films, laminate structures, single layer substrate, including but not limited to, multi-layer paper-polymer laminate, paper-Aluminum laminate, polymeric laminate, single or multilayer polymeric films, fibrous substrate, woven polymeric fabric and its laminates, metal foils, etc.

Examples of fibrous substrate may include a natural fiber substrate like paper (coated or uncoated), paperboard, non-woven, woven substrate of synthetic fibers and polymeric tapes.

Further, examples of single or multilayer polymeric films may include one of or combination of Polyethylene (PE), Biaxially-Oriented Polypropylene (BOPP) film, Polyvinyl Chloride (PVC) film, Cast Polypropylene (CPP) film, Biaxially-Oriented Polyethylene Terephthalate (BoPET), Polyamide (PA), Acrylic (Polymethyl methacrylate) (PMMA) and Ethylene Vinyl Acetate (EVA) or any other polymer.

Examples of metal foil may include metalized layer of Aluminum, Aluminum Oxide, zinc sulphide, Silicon Oxide, Silver, Gold, Copper, Chrome, silicon monoxide, silicon dioxide, magnesium fluoride, titanium dioxide, tin tungsten oxide and indium tin oxide or any other suitable metal.

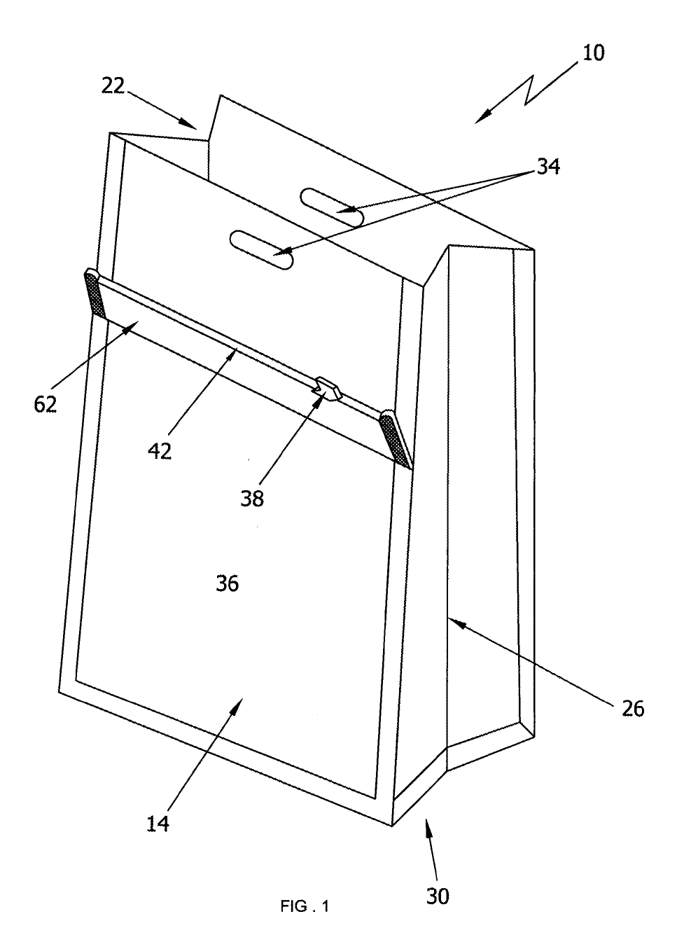

Referring to FIG. 1, a three side gusseted re-closable package (hereinafter referred as package (10)) is shown as an exemplary embodiment of the present invention. The package (10) comprises a first panel (14) or rear panel and a second panel (18) or front panel configured with the first panel (not shown the FIG. 1), a left side gusset (22), a right side gusset (26), a bottom gusset (30), and a punched carry handle (34). The side gussets (22, 26) are disposed between the first panel (14) and the second panel (18) and sealed along their longitudinal sides. The bottom gusset (30) disposed between the first panel (14) and the second panel (18) and sealed along the bottom sides of both the panels. The side gussets and the bottom gusset are provided to form a volume (36) inside the package (10). The first panel (14) further comprises a pair of extended panels (62). A re-closable zipper (42) is sealed with the inner surface of the extended panels (62) for opening and closing of the package (10). In an embodiment of the present invention the re-closable zipper (42) may be a press-to-close type or provided with a slider (38) as shown in FIG. 1.

The package (10) shown is open from the top only for the sake of explanatory reason, otherwise in practice the sealing above the zipper (42) is also done.

The package (10) comprises optionally side gussets such as the left side gusset (22), the right side gusset (26) and the bottom gusset (30). The side gussets and the bottom gusset are majorly provided to increase the volume of the package (10). But in some of the embodiments the package (10) may be made one or more gussets or without gusset as per the requirement of the user.

The re-closable package (10) as shown in FIG. 1, is provided with at least one opening or open side to enable the filling of product into the package (10) and the said opening is sealed after filling the package (10). The opening may be provided along any one of the edges of the package (10) and subsequently seal the said open side after filling the package (10). The opening may be provided at the extended panel by sealing the re-closable zipper (42) with any one extended panel to enable the filling of product through the open extended panel into the package (10), and the said re-closable zipper (42) is sealed with other extended panel after filling the package (10).

The re-closable package (10) as shown in FIG. 1, may be provided with one or more handle at predetermined location(s). The handle can be provided by punching, sealing or by any other way known to the person skilled in the art.

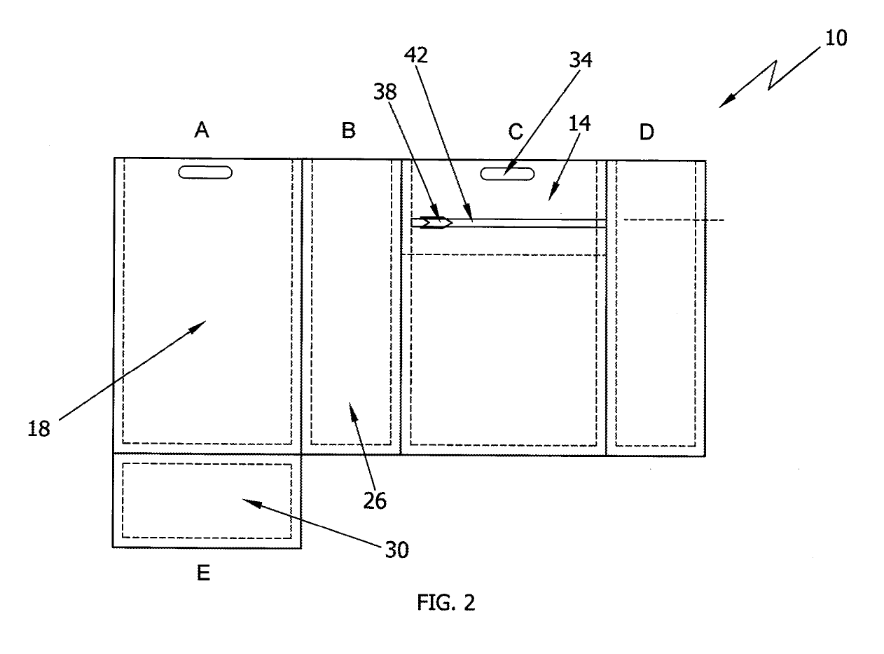

Referring now to FIGS. 2A-2E, showing the various portions of the package (10). FIG. 2A shows the front view of the package (10) thereby showing the second panel (18) or front panel (18). FIG. 2B shows the right side gusset (26) of the package (10). FIG. 2C shows the rear view of the package (10) showing the first panel (14) or rear panel (14). The first panel (14) further comprises the zipper (42). FIG. 2D shows the left side gusset (22) of the package (10) and FIG. 2E shows the bottom gusset (30) of the package (10).

FIGS. 2A & 2C comprise the punched carry handle (34) at the top of the package (10) for carrying the package (10). The FIG. 2C comprises the zipper (42) with slider (38) below the carry punch handle (34).

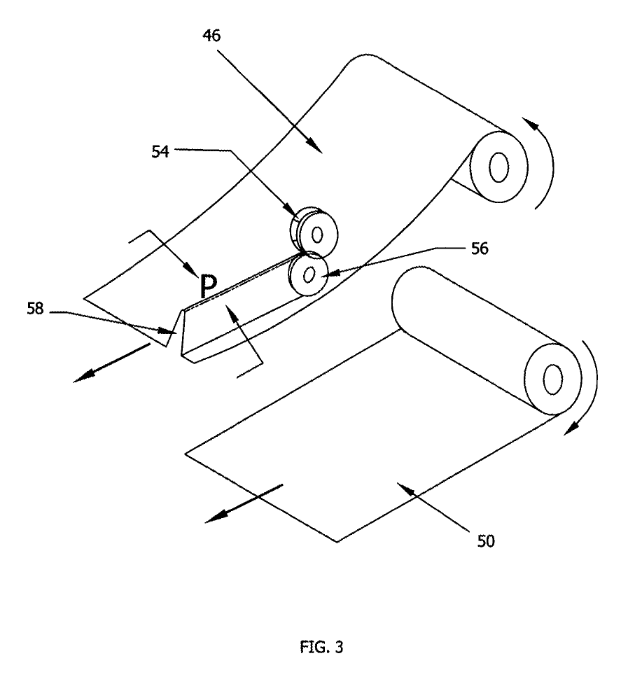

FIGS. 3-8 show steps for making the package (10).

Referring to FIG. 3, a first web (46) is provided in roll to form the rear panel (14) of the package (10). Similarly, a second web (50) is provided in roll to form the front panel (18) of the package (10). The second web (50) is configured with the first web thereby forming the package (10). A V-folding female roller (54) and a V-folding male roller (56) as depicted in the FIG. 3, wherein the V-folding female roller (54) and the male roller (56) are configured to fold a portion (P) of the first web (46) at a predetermined location in a V-shape (58) by pressing the portion between the two rollers. It is to be noted that the width of the first web (46) is more than that of the second web (50). The difference in width is provided to obtain the folded portion to form the V-shape (58).

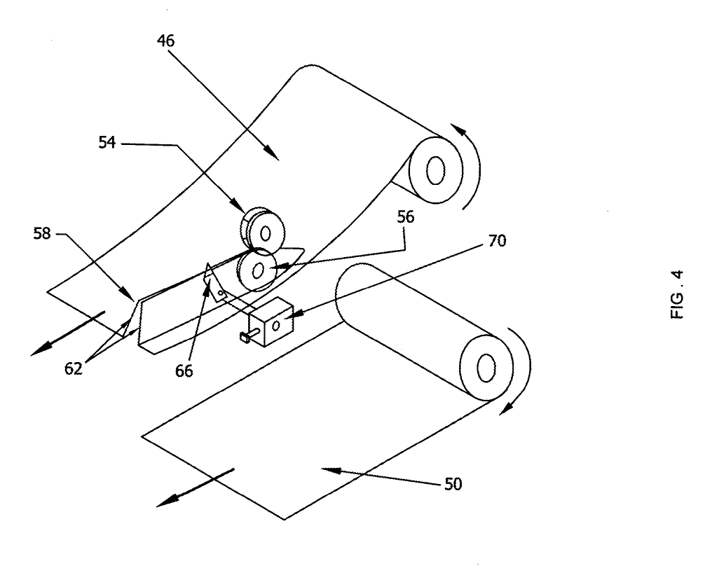

Referring to FIG. 4, a blade (66) is coupled to a blade holder (70) which is located adjacent to the first web (46). The blade (66) slits the folded portion of V-shape (58) to form the pair of extended panels (62).

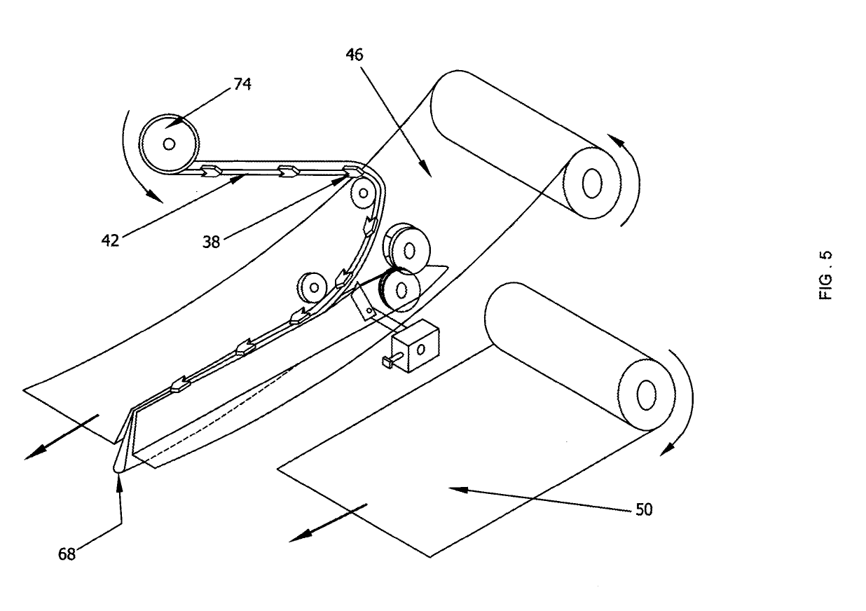

Referring to FIG. 5, insertion of the re-closable zipper (42) with slider (38) configured at predetermined distance according to the width of the bags, on the extended panels (62) of the web of the first panel (14) is shown as an exemplary embodiment. Here shown in FIG. 5 is the re-closable zipper (42) with the slider (38). In some of the embodiments, the re-closable zipper (42) may be a press-to-lock (PTC) zipper. A tamper evident diaphragm (68), with or without scoring for easy tear, may be configured with the fins of the re-closable zipper (42) according to an embodiment of the present invention. The re-closable zipper (42) may be in roll form over a spool (74) or in a box. The re-closable zipper is pulled and subsequently the sliders are assembled with the zipper at predefined pitch. It may be contemplated that the re-closable zipper (42) provided to the package (10) may or may not have a slider assembled therewith before sealing of the re-closable zipper (42) with the extended panels (62). The slider may be assembled with the re-closable zipper (42) in later stage, after sealing of the re-closable zipper (42) with the extended panels (62).

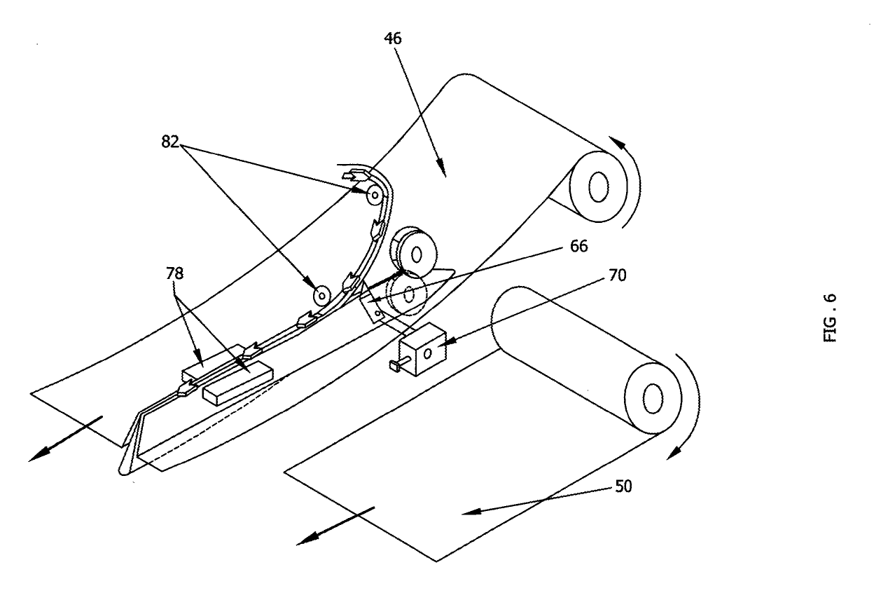

As the first panel (14) is cut, the zipper (42) is placed and sealed on atleast one of the extended panels (62) of the first panel (14), as shown in FIG. 6. In case the package is to be filled from bottom side or top side of the package then the zipper is sealed with both the extended panels (62). However in an alternate embodiment the package is pre-sealed from bottom and top sides and filling of product is required to be done from extended panels then only one side of the re-closable zipper (42) is sealed with one of the extended panels (62). The other side of the re-closable zipper (42) is sealed with the unsealed extended panel after filling the content. Referring to FIG. 6, the sealing of the zipper (42) is done by means of a zipper sealer (78). The zipper sealer (78) is located ahead of the blade (66) in the direction of the movement of the first web (46). For synchronizing and guiding the movement of the zipper (42) and attaining proper tension, plurality of rollers (82) are placed at different sections. It is evident that after sealing of the zipper (42) with the pair of extended panels (62), the plane of the first panel (14) is dissimilar to that of the extended panels and thereby the zipper (42).

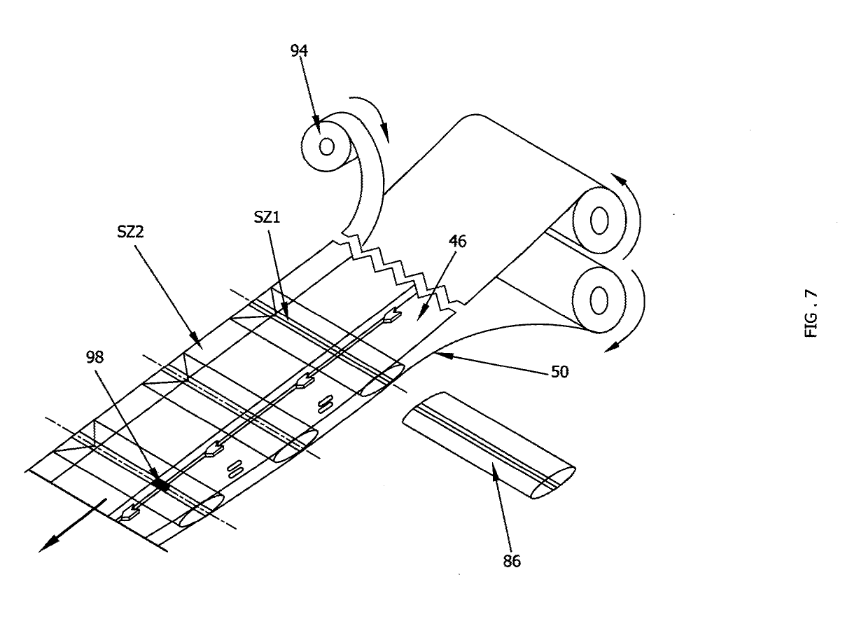

As shown in FIG. 7, after the sealing of the zipper (42) with the first panel (14), a side gusset tube (86) is fed and sealed to the second web (50) and subsequently with first web (46) at a sealing zone(s) (SZ1). It is very much evident from the figure that the side gusset tube (86) is fed in the direction perpendicular to the movement of the webs (46, 50).

It should be appreciated that placement and sealing of the side gusset tube (86) is optional and may not be used depending on the requirement. In such cases the sealing of the first web (46) and the second web (50) is done directly at the sealing zone(s) (SZ1) which may be at one or multiple zones.

The sealing zone(s) (SZ1) forms a sealing band between two consecutive packages. The zipper is pinched and melted in the sealing band to form protrusion at (98), which later act as end closure for zipper (42) and also acts as end stops for the slider (38) according to an embodiment of the present invention.

For thorough understanding of the sealing of the side gusset tube (86) to the web of the first panel (14) and the web of the second panel (18) one can refer U.S. Pat. No. 8,226,534 B2.

In an exemplary embodiment, after sealing of the side gusset tube (86) with the first and second webs (46, 50), the bottom gusset web (94) is sealed to the first and second webs (46, 50) and at one end of the side gusset tube (86) at a sealing zone (SZ2). The feeding of the bottom gusset web (94) starts from a roll. The bottom gusset web (94) advances continuously from one side of the first and second web (46, 50) and subsequently sealed with the first web (46), the second web (50) and the side gusset tube (86). In case when no bottom gusset web (94) is used, then the first web (46) is sealed to the second web (50) at the sealing zone (SZ2). The sealing zone (SZ2) is a predefined location transverse to the movement of the first web (46) and the second web (50).

For thorough understanding of the sealing of the bottom gusset web (90) to the first and second web and side gusset tube, one can refer U.S. Pat. No. 8,226,534 B2.

The sealing described above can be any method which is suitable between panels, side gusset tube and the bottom gusset available in the prior art. The zipper is pinched and melted by hot punch or ultrasonic energy to form a protrusion at (98), which later act as end stops for the slider (38) according to an embodiment of the present invention.

Shown again in FIG. 7, each of the side gusset tube (86), duly sealed with first web (46) and second web (50), is slit/cut across the width in the middle of the protrusion at (98) created by first sealing zone(s) (SZ1) to produce the package (10) as shown in FIG. 1. This cutting separates one package from the following package.

In some of the embodiments if the side gusset tube (86) is not used, then the first web (46) and second web (50) are sealed together at sealing zone(s) (SZ1). The sealed webs (46, 50) are slit/cut across the width in the middle of the protrusion at (98) formed by pinching and melting of the re-closable zipper (42) so as to obtain a package (10) without side gussets.

The present invention is advantageous in providing a package that has a re-closable zipper on one side of the panel having appropriate opening and one can easily put his hand inside through the opening to access the content.

The foregoing descriptions of specific embodiments of the present invention have been presented for purposes of illustration and description. They are not intended to be exhaustive or to limit the present invention to the precise forms disclosed and sequence of steps disclosed, and obviously many modifications and variations are possible in light of the above teaching. The embodiments were chosen and described in order to best explain the principles of the present invention and its practical application, thereby enabling other person skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

1. A method of making a re-closable package (10), the method comprising the steps of:
providing a first web (46) for forming a first panel (14);
folding a predetermined portion (P) of the first web (46) into a V-shape (58) thereby forming an extended portion;
slitting the V-shape (58) of the first web (46), thereby forming a pair of extended panels (62) from the extended portion;
inserting and sealing a re-closable zipper (42) with the extended panels (62);
providing a second web (50) for forming a second panel (18);
sealing the first web (46) with the second web (50) at a first sealing zone(s) (SZ1) thereby forming a sealing band, wherein the first sealing zone(s) (SZ1) is provided at predetermined pitch, transverse to the movement of the first web (46) and the second web (50);
sealing the first web (46) with the second web (50) at a second sealing zone (SZ2), wherein the second sealing zone (SZ2) is at predefined location along the movement of the first web (46) and the second web (50); and
slitting/cutting the sealing band transverse to the movement of the first web (46) and the second web (50) to obtain the re-closable package (10).

2. The method as claimed in claim 1, wherein the width of the first web (46) is larger than that of the second web (50).

3. The method as claimed in claim 1, wherein the re-closable zipper (42) is provided with a slider (38).

4. The method as claimed in claim 3, wherein the slider (38) is assembled with the re-closable zipper (42) before sealing of the re-closable zipper (42) with the extended panels (62).

5. The method as claimed in claim 3, wherein the slider (38) is assembled with the re-closable zipper (42) after sealing of the re-closable zipper (42) with the extended panels (62).

6. The method as claimed in claim 1, wherein the re-closable zipper (42) is press to lock type.

7. The method as claimed in claim 1, wherein the re-closable zipper (42) is provided with a tamper evident diaphragm (68).

8. The method as claimed in claim 1, wherein the predetermined portion (P) of the first web (46) is folded into V-shape (58) by passing the portion (P) in between a V-folding male roller (56) and a V-folding female roller (54).

9. The method as claimed in claim 1, wherein the first web (46) and the second web (50) are provided with a side gusset tube (86) disposed between first web (46) and the second web (50), the said side gusset tube (86) is sealed with the first and second webs (46, 50) along the first sealing zone(s) (SZ1) to provide side gussets to the package (10).

10. The method as claimed in claim 9, wherein the first web (46), the second web (50) and the side gusset tubes (86) are sealed with a bottom gusset web (94) along the second sealing zone (SZ2) thereby providing a bottom gusset (30) to the package.

11. The method as claimed in claim 1, wherein the first web (46) and the second web (50) are sealed with a bottom gusset web (94) along the second sealing zone (SZ2) thereby providing a bottom gusset (30) to the package.

12. A re-closable package (10) comprising:
a first panel (14) comprising
a pair of extended panels (62) protruding outwardly from the first panel (14) at predetermined location on the said first panel (14); and
a re-closable zipper (42) sealed with the said extended panels (62);
a second panel (18) sealed with the said first panel so as to form a volume (36) in the said re-closable package (10).

13. The re-closable package (10) as claimed in claim 12, wherein the re-closable zipper (42) is provided with a slider (38).

14. The re-closable package (10) as claimed in claim 12, wherein the re-closable zipper (42) is press to lock type.

15. The re-closable package (10) as claimed in claim 12, wherein a tamper evident diaphragm (68) is provided with the zipper (42).

16. The re-closable package (10) as claimed in claim 15, wherein the tamper evident diaphragm is provided with a perforation line/laser scoring at predetermined location.

17. The re-closable package (10) as claimed in claim 12, wherein the re-closable package (10) further comprises a pair of side gussets i.e. a left side gusset (22) and a right side gusset (26) sealed along longitudinal sides of the first panel (14) and the second panel (18).

18. The re-closable package (10) as claimed in claim 12, wherein the re-closable package (10) comprises a bottom gusset (30) sealed along bottom sides of the first panel (14) and the second panel (18).

19. The re-closable package (10) as claimed in claim 12, wherein the re-closable package (10) comprises a pair of side gussets i.e. a left side gusset (22) and a right side gusset (26) sealed along longitudinal sides of the first panel (14) and the second panel (18) and a bottom gusset (30) sealed along bottom sides of the first panel (14), second panel (18) and the side gussets (22, 26).

20. The re-closable package (10) as claimed in claim 12, wherein the package is provided with at least one opening to enable the filling of product into the package (10) and the said opening is sealed after filling the package (10).

21. The re-closable package (10) as claimed in claim 20, wherein the package is provided with at least one open side along edges of the package (10) to enable the filling of product into the package (10), the said open side is sealed after filling the package (10).

22. The re-closable package (10) as claimed in claim 20, wherein the package is provided with an opening at the extended panel by sealing the re-closable zipper (42) with at least one extended panel to enable the filling of product into the package (10), and the said re-closable zipper (42) is sealed with another extended panel after filling the package (10).

23. The re-closable package (10) as claimed in claim 12, wherein the re-closable package (10) is provided with one or more handle at predetermined location(s).

24. The re-closable package (10) as claimed in claim 12, wherein the re-closable package (10) is made by using a single or multilayer polymeric films of Polyethylene (PE), Biaxially-Oriented Polypropylene (BOPP) film, Polyvinyl Chloride (PVC) film, Cast Polypropylene (CPP) film, Biaxially-Oriented Polyethylene Terephthalate (BoPET), Polyamide (PA), Acrylic (Polymethyl methacrylate) (PMMA), and Ethylene Vinyl Acetate (EVA) or any other polymer or combination thereof, laminate structures, single layer substrate, multi-layer paper-polymer laminate, paper-Aluminum laminate, polymeric laminate, woven polymeric fabric and its laminates, metal foils or fibrous substrate such as a natural fiber substrate, coated or uncoated paper, paperboard, non-woven, woven substrate of synthetic fibers and polymeric tapes.
